(19) United States
(12) Patent Application Publication
(10) Pub. No.: US 2026/0249232 A1
(43) Pub. Date: Aug. 27, 2026

(54) GAS SORPTION ROTOR FOR AIR TREATMENT AND METHOD FOR MANUFACTURING SUCH GAS SORPTION ROTOR

(71) Applicant: Munters Europe Aktiebolag, Kista (SE)

(72) Inventor: Luciano UNGARELLI, Sundbyberg (SE)

(21) Appl. No.: 19/489,707

(22) PCT Filed: Jun. 3, 2024
(86) PCT No.: PCT/EP2024/065190

§ 371 Date: Dec. 3, 2025

(30) Foreign Application Priority Data
Jun. 9, 2023 (SE) 2350702-3

(51) Int. Cl. B01D 53/06; B01J 20/28; B01J 20/30; B23K 26/352

(52) U.S. Cl. CPC B01D 53/06; B01J 20/2804; B01J 20/28045; B01J 20/3007; B23K 26/352; B01D 2258/06

(57) ABSTRACT

A gas sorption rotor for air treatment including a rotor media with corrugated panels forming channels extending in an axial direction through the gas sorption rotor, in parallel with a rotational axis of the gas sorption rotor. The gas sorption rotor has a first side, a second side opposite to the first side and a circumferential side. The channels extend from the first side to the second side. The gas sorption rotor includes at least one rotor section of rotor media having an at least partly laser marked surface, the at least partly laser marked surface being on at least one of the first and second side of the gas sorption rotor.

### TECHNICAL FIELD

The present invention relates to a gas sorption rotor for air treatment and a method for manufacturing such gas sorption rotor.

### BACKGROUND ART

Air treatment systems of various kinds are commonly used for providing treated process air into a defined space. Such air treatment systems normally comprise some sort of gas sorption device with a gas sorption element. One example of such air treatment system involves a gas sorption rotor, commonly a desiccant rotor. Such rotors comprise a sorption media, also called rotor media, which consists of corrugated panels forming axially extending channels through the rotor media. The rotor rotates slowly between a process and a regeneration airstream and the gas sorption rotor typically comprises a process section and a regeneration section. The process air flows through the channels of the rotor media and the rotor media either adsorbs or absorbs moisture. When the gas sorption rotor rotates, the rotor media is heated by the hot regeneration air, and the rotor media releases its moisture into the regeneration air. Following regeneration, the gas sorption rotor rotates back into the process airstream, where the process repeats itself.

The gas sorption rotor is normally rotatably arranged within a rotor cassette. In order to avoid mixing of the airstreams and undesirable air leakage, a seal is used between the rotor cassette and the gas sorption rotor. To ensure a tight seal between the rotor media and the seal and/or rotor cassette, it is essential that the surfaces of the rotor media corresponding to the air inlet side and the air outlet side of the gas sorption rotor are as even as possible. A surface with a reduced amount of irregularities will result in less friction against the seal during rotation of the gas sorption rotor, and this is both energy and material saving. Today, gas sorption rotors are typically sanded to flatten the surfaces but this may not always be enough. Thus, there is a need to improve the surfaces on the gas sorption rotor.

### SUMMARY OF THE INVENTION

It is an object of the present invention to mitigate, alleviate or eliminate one or more deficiencies and disadvantages in the prior art and solve at least the above-mentioned problems.

Another object of the present invention is to achieve a gas sorption rotor and a method for manufacturing such a gas sorption rotor, which will reduce irregularities of the rotor surfaces and thereby reduce friction against seals and increase energy efficiency.

According to a first aspect of the present disclosure, there is provided a gas sorption rotor for air treatment, the gas sorption rotor comprising a rotor media with corrugated panels forming channels extending in an axial direction through the gas sorption rotor, in parallel with a rotational axis of the gas sorption rotor, the gas sorption rotor comprising a first side, a second side opposite to the first side, and a circumferential side, wherein the channels extend from the first side to the second side, wherein the gas sorption rotor comprises a rotor section of rotor media having an at least partly laser marked surface, the at least partly laser marked surface being on at least one of said first and second side of the gas sorption rotor.

The rotor media may be referred to as sorption media or honeycomb media and the channels formed by the corrugated panels may be referred to as flutes. The rotor media may comprise a corrugated fiberglass structure, which contains a hygroscopic desiccant such as silica gel, lithium-chloride or hydrophobic zeolite adsorbent. The gas sorption rotor can suitably be a desiccant rotor such as an adsorption rotor or and absorption rotor. It is to be understood that even though the rotor media is described herein as having channels extending axially in parallel with the rotational axis, the gas sorption rotor may comprise a rotor media having channels extending radially and/or axially and/or in any direction through the gas sorption rotor.

The at least partly laser marked surface may be an at least partly laser engraved surface and means that the surface has been, at least partly, treated with laser to remove microscopic layers of material. Laser marking at least a part of at least one surface of the rotor media includes slightly burning the top surface of the rotor media with a thin and programmable laser beam. It is to be understood that even though an at least partly laser marked surface is described herein, the gas sorption rotor could additionally or alternatively comprise a rotor section of rotor media having a surface which is at least partly treated with a heat stamp. Thus, the gas sorption rotor may comprise a rotor section of rotor media having an at least partly heat-treated surface. The general technique of laser marking or laser engraving is considered to be commonly known and will not be discussed in detail herein. By laser marking at least a part of at least one surface on the first and/or second side of the gas sorption rotor, surface imperfections can be removed and the surface will become smoother. By smooth means that the surface is free from perceptible projections, lumps, or indentations. A smoother surface will increase the sealing capability and reduce friction against the seal of the gas sorption rotor. Less energy to drive the gas sorption rotor will thereby be required. Suitably, the rotor section comprises an at least partly laser marked surface on both the first and the second side of the gas sorption rotor. The rotor media is a highly porous composite material with a brittle surface, this makes it specifically advantageous to use laser to smoothen the surface. Since the laser marking is a light and not a machining tool, the risk of breaking or damaging the rotor media during surface treatment is reduced.

The gas sorption rotor may comprise two or more rotor sections assembled to form a complete annular-shaped rotor. Alternatively, the gas sorption rotor consists of one annular-shaped rotor section. The first and second side of the gas sorption rotor corresponds to a first and second side of a rotor section of rotor media. The first and second side of the gas sorption rotor may be referred to as air inlet side and air outlet side. Thus, the channel openings are on the first and second side of the gas sorption rotor. The axial extension of the gas sorption rotor is between the first side and the second side. A surface on the first and/or second side of the gas sorption rotor is essentially flat. The circumferential side of the gas sorption rotor extends around the circumference of the gas sorption rotor. A surface on the circumferential side is a curved surface. It is to be understood that a rotor section may comprise a plurality of peripheral sides, wherein one peripheral side will form part of the circumferential side of the assembled gas sorption rotor. The other peripheral sides of a rotor section will each face a peripheral side of another rotor section when being assembled. The gas sorption rotor may comprise partition plates arranged between peripheral sides of different rotor sections. Thus, a peripheral side of the rotor section may abut a partition plate.

The gas sorption rotor may comprise a plurality of at least partly laser marked surfaces on the first and/or second side of the gas sorption rotor. A plurality of rotor sections, or all rotor sections, of the gas sorption rotor may have at least partly laser marked surfaces on the first and/or second side of the gas sorption rotor. It is to be understood that the whole surface on the first and/or second side of a rotor section may be laser marked. Similarly, the whole surface on the first and/or second side of the gas sorption rotor may be laser marked.

According to an example, the circumferential side of the gas sorption rotor comprises an at least partly laser marked surface.

According to an example, the at least partly laser marked surface of the rotor section comprises a mark configured to enable identification of a rotor media configuration of said rotor section. The mark may be a pattern, code or any other graphical marking suitable for recognising, identifying or tracing the rotor section.

The mark may be configured to enable optical identification of the rotor media configuration of the rotor section.

The gas sorption rotor may further comprise a transparent coating applied on the at least partly laser marked surface on the first and/or second side of the gas sorption rotor.

The manufacturing process for manufacturing a gas sorption rotor today typically comprises spraying a coating on the separate rotor sections before they are assembled into a gas sorption rotor. The coating is applied for the purpose of hardening the surfaces of the rotor sections but also comprises colour pigments for identification. The coating is thus typically a coloured coating where a certain colour corresponds to a certain rotor media configuration. Gas sorption rotors are configured in different ways depending on the application in which they will be used. The corrugation (flute or channel) dimensions of the rotor media will vary as well as material treatments of the rotor media. The rotor media configuration of a rotor section may thus relate to channel dimensions and/or material treatment of the rotor media. The specific rotor media configuration of a rotor section needs to be identified both during the manufacturing process, when assembling the rotor sections, and at the user premises to know which rotor or rotor section to install where. Furthermore, service and maintenance is facilitated if there is an identification of the rotor media configuration on the rotor sections, such that a rotor section is replaced by a similar rotor section.

The colour coating that is applied on the rotor sections today makes the surface harder for mechanical requirements. This is important since the rotor media abuts seals and/or the rotor cassette. The rotation of the gas sorption rotor will cause wear of the rotor media and therefore the outer surface needs to be hardened. The pigments in the coating gives the gas sorption rotor its identity but also covers spots and anomalies of the raw material and thus improves the visual impression of the gas sorption rotor. The coating is today sprayed onto the rotor sections and the depth and reach of the coating is therefore variable and unpredictable. Also, the coloured coating may clog some of the channels, which will affect the functionality of the gas sorption rotor. Furthermore, the pigments have a great impact on the environment in a negative way. By laser marking the surfaces of the gas sorption rotor, the surfaces become smoother but the rotor sections can also, at the same time, be provided with an identification mark such that there is no longer a need for colour pigments in the coating. Thus, laser marking the gas sorption rotor enables removal of the colour pigments from the coating. Removing colour pigments from the coating will give a more sustainable solution, reduce costs and improve the manufacturing lead times. However, only using a clear coating would not solve the problem of covering any spots or anomalies, and would not help identifying the configuration of the rotor media with regard to material treatments or corrugations. Therefore, the laser marking of at least a part of the at least one surface may be performed to comprise a mark, code or similar for identification of the rotor section. Thus, a certain mark corresponds to a certain rotor media configuration. The mark may be configured to cover any spots or anomalies of the rotor media. The mark may indicate how and/or where the rotor section is to be mounted or assembled.

In one example, the mark is configured to enable optical identification of the rotor media configuration of the rotor section. The mark may thus comprise a QR-code, a bar code or similar. The mark can this way indirectly comprise information about the manufacturing batch of the specific rotor section or any other information related to the rotor section. This could be advantageous for example for traceability.

According to another aspect of the present disclosure, a method for manufacturing a gas sorption rotor for air treatment is provided, the method comprising: forming a block of rotor media, the rotor media comprising corrugated panels forming channels extending through the block, from a first side to a second opposite side of the block, the first side and the second side of the block corresponding to a first side and second side of the final gas sorption rotor; and machining the block into at least one rotor section for a gas sorption rotor, wherein the method further comprises laser marking at least a part of at least one surface of the rotor media, such that the at least one rotor section will have an at least partly laser marked surface on a side corresponding to the first and/or second side of the gas sorption rotor. Features and advantages related to the gas sorption rotor as disclosed herein are also applicable on the method for manufacturing such gas sorption rotor.

It is to be understood that even though the method for manufacturing a gas sorption rotor herein is described to include the step of laser marking at least a part of at least one surface of the rotor media, the method may additionally or alternatively comprise a step of heat stamping at least a part of at least one surface of the rotor media.

The first and second side of the block of rotor media corresponds to the first and second side of the rotor section and the first and second side of the gas sorption rotor. Thus, the method comprises laser marking at least a part of at least one surface on the first and/or second side of the rotor media.

The step of forming a block of rotor media may comprise performing a first material treatment of the raw material used for the gas sorption rotor. The raw material may be rolls of glass fibre. The first material treatment may involve chemical dipping of the raw material and the chemical treatment depends on the application for which the gas sorption rotor will be used. After the first material treatment, the treated raw material may be heated to fix and dry the material. Subsequently, the material is corrugated and panels including one corrugated sheet and one flat sheet of material are formed. The panels are then stacked into a block of rotor media to create a desired volume.

The step of machining the rotor media block into rotor sections may be performed by means of CNC machining.

The method may further comprise a second material treatment of the block of rotor media. The second material treatment may involve chemical dipping of the block. After such material treatment, the block is typically dried for hardening and this may also cause a change of colour of the rotor media.

The step of laser marking at least a part of at least one surface of the rotor media on a side corresponding to the first and/or second side of the gas sorption rotor may comprise creating a mark configured to enable identification of a rotor media configuration of said rotor section. The mark may be configured to enable optical identification of the rotor media configuration of the rotor section. The mark may thus comprise a QR-code, a bar code, or any other standard/proprietary codes for ID. The mark could also include a company's logotype or similar to personalize the gas sorption rotor. The step of at least partly laser marking the at least one surface may be an iterative process where the whole surface is first laser marked with a first relatively low intensity and/or power to make the surface smooth and subsequently a mark is created by performing laser marking on specific parts of the surface with a second increased intensity and/or power. Alternatively, the laser marking is performed in one step, alternating between different intensities and/or powers.

The method may further comprise applying a transparent coating on the at least partly laser marked surface on the first and/or second side of the gas sorption rotor. The coating will harden the surface. Using a transparent coating will, in addition to the previously mentioned advantages, also facilitate manufacturing and improve the working environment. The coating may be applied in conventional ways, for example by spraying the coating over the rotor media. The method may alternatively comprise applying a coloured coating on the rotor media.

In one example, the laser marking is performed on the block of rotor media, prior to the machining of the block into at least one rotor section. Performing the laser marking prior to the machining is advantageous because it enables making a marking that indicates a shape of a rotor section to be machined from the block of rotor media. Thus, the laser marking may be performed over a predetermined area of the rotor media surface corresponding to a shape of a rotor section, such that it becomes visible for a person and/or a machine how to control the machining of the block into rotor sections. The marking may for example include the outline of the shape of a rotor section. The block of rotor media may be used to cut out multiple rotor sections and the laser marking may this way act as guide as to where to cut and will facilitate the machining process. Furthermore, laser marking the rotor media block prior to machining makes it possible to give the rotor sections an identity in a previous stage compared to how it is done today, where the colour coating gives the identity of the rotor sections. Giving the rotor sections an identity as early as possible in the manufacturing process is advantageous and will reduce the risk of mixing up rotor sections from different blocks after machining.

In another example, the laser marking is performed on the rotor media after machining the block into at least one rotor section. Thus, the laser marking may be performed on the created rotor section.

The step of laser marking may further comprise laser marking at least a part of a surface on a side of the at least one rotor section corresponding to the circumferential side of the gas sorption rotor. Thus, the laser marking of the rotor media may comprise laser marking a peripheral side of the rotor section.

The method may also comprise a step of sanding the first and second side of the rotor media block, wherein the laser marking is performed after the sanding. By sanding the rotor media block, the surfaces are flattened and more even/planar surfaces are achieved.

The method may also comprise the step of assembling rotor sections into a gas sorption rotor.

### BRIEF DESCRIPTION OF THE DRAWINGS

The above objects, as well as additional objects, features and advantages of the present invention will be more fully appreciated by reference to the following illustrative and non-limiting detailed description of example embodiments of the present disclosure, when taken in conjunction with the accompanying drawings.

FIG. 1 schematically illustrates a gas sorption rotor according to an example of the present disclosure;

FIG. 2a-b schematically illustrate rotor media of a gas sorption rotor according to examples of the present disclosure;

FIG. 3 schematically illustrates an example of a laser marked surface on a gas sorption rotor;

FIG. 4 schematically illustrates an example of a laser marked surface on block of rotor media;

FIG. 5 illustrates a rotor media surface being laser marked; and

FIG. 6 schematically illustrates a method for manufacturing a gas sorption rotor according to the present disclosure.

### DETAILED DESCRIPTION

The present invention will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed invention is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Furthermore, the words “comprising”, “including”, “containing” and similar wordings do not exclude other elements or steps.

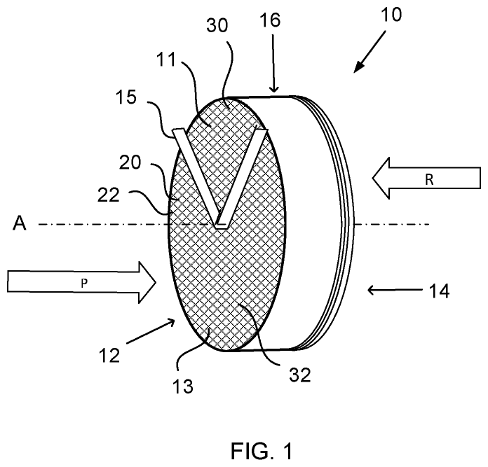

FIG. 1 schematically illustrates a gas sorption rotor 10 for air treatment according to an example of the present invention. The gas sorption rotor 10 comprises a rotor media 20. The rotor media 20 typically comprises a corrugated fiberglass structure, which contains a hygroscopic desiccant such as silica gel, lithium-chloride or hydrophobic zeolite adsorbent. The rotor media 20 comprises channels 22 axially extending in parallel with a rotational axis A of the gas sorption rotor 10.

The gas sorption rotor 10 has a first side 12, a second opposite side 14, and a circumferential side 16. Gas sorption rotors are well known in the art and normally comprise at least one regeneration section 11 and one process section 13 as shown in this figure. In addition, the gas sorption rotor 10 may include a purge section (not shown). In this example, a divider 15 separates the regeneration section 11 from the process section 13. Although only one regeneration section is shown in FIG. 1, the disclosure herein is also compatible with rotors having several and/or divided regeneration sections. Furthermore, the disclosure herein is compatible with rotors having separated purge zones and/or other divisions of the rotor. The arrows P and R in FIG. 1 represent the flow of process air through the process section 13 and regeneration air through the regeneration section 11, respectively.

The gas sorption rotor 10 comprises at least one rotor section 30 of rotor media having an at least partly laser marked surface 32 on the first side 12 and/or the second side 14 of the gas sorption rotor 10. The laser marking makes the surface 32 smoother. Typically, the whole rotor media surface 32 on the first side 12 and/or the second side 14 of the gas sorption rotor 10 is laser marked.

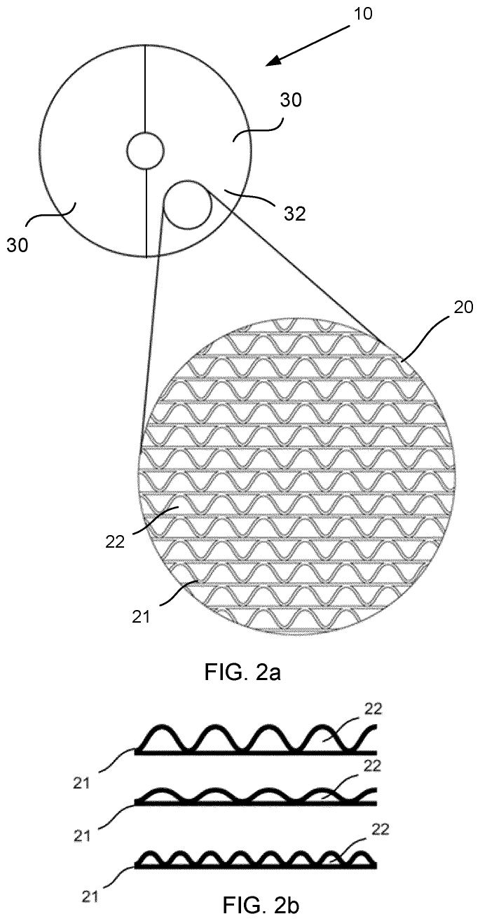

FIG. 2a-b schematically illustrate rotor media of a gas sorption rotor 10 for air treatment according to different examples of the present invention. The gas sorption rotor 10 may be configured as in FIG. 1. FIG. 2a shows a gas sorption rotor 10 and an enlarged view of a part of the gas sorption rotor 10 showing the rotor media 20. In this example, the gas sorption rotor 10 comprises two rotor sections 30 of rotor media 20. The enlarged view shows the channels 22 of the rotor media 20 being formed by corrugated panels 21 stacked on each other. Gas sorption rotors are differently configured depending on the application in which it will be used. The channel or flute dimension is one thing that differs between different gas sorption rotors. A number of different corrugated panels 21 with different channel configurations are shown in FIG. 2b.

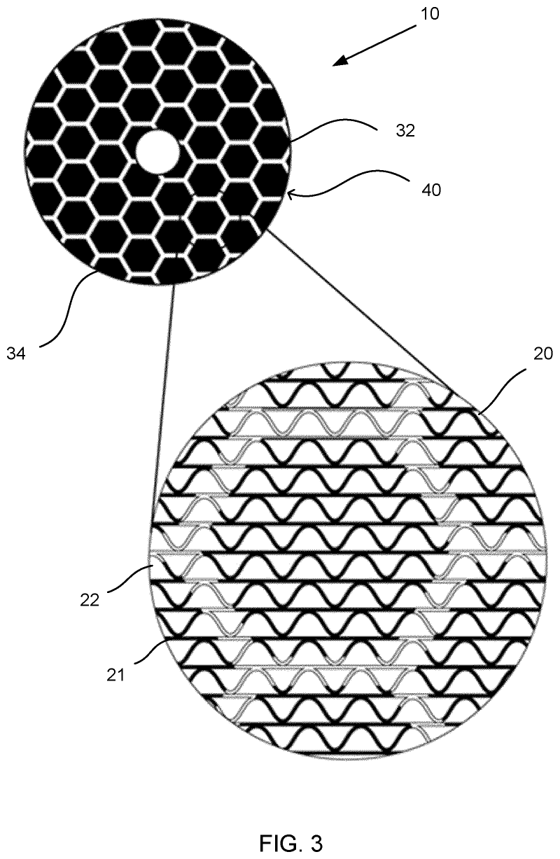

FIG. 3 schematically illustrates a gas sorption rotor 10 for air treatment according to an example of the present invention. The gas sorption rotor 10 may be configured as in FIG. 1. In this example, the at least partly laser marked surface 32 comprises a mark 34 configured to enable identification of a rotor media configuration of the gas sorption rotor 10. In this example, the whole surface on the first and second side 12, 14 of the gas sorption rotor 10 is laser marked and the mark 34 comprises a lighter honeycomb pattern on a darker background. This mark 34 thus corresponds to a specific rotor media configuration of the gas sorption rotor 10, wherein the rotor media configuration may relate to material treatment of the rotor media 20 and/or the channel dimensions. The darker parts are achieved by using a higher intensity and/or power when laser marking the surface 32. The gas sorption rotor 10 optionally comprises a transparent coating 40 over the surfaces 32 on the first 12 and second 14 side of the gas sorption rotor 10.

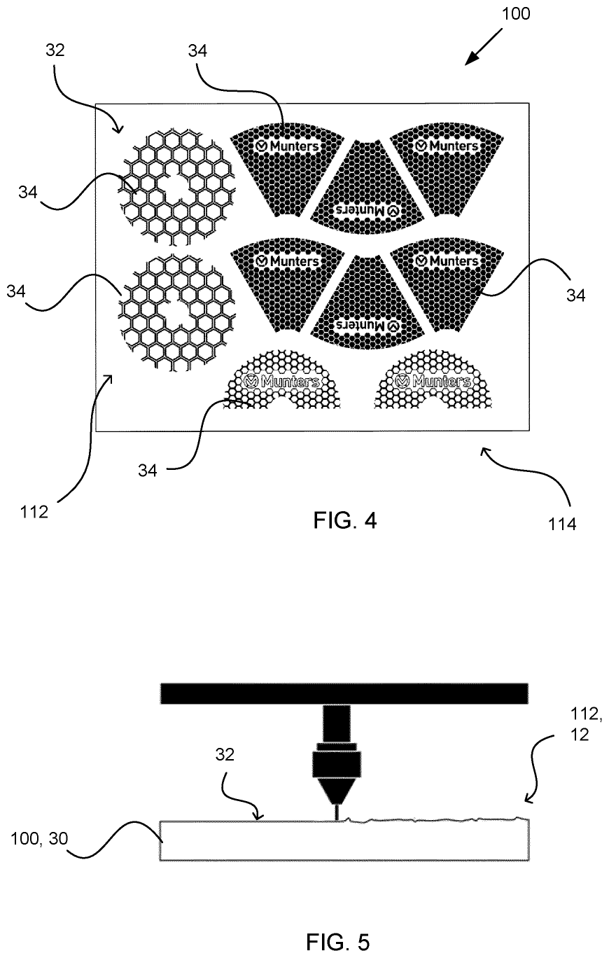

FIG. 4 shows a block 100 of rotor media used when manufacturing a gas sorption rotor 10 according to the present invention. The block 100 of rotor media 20 comprises an at least partly laser marked surface 32 on a first side 112 corresponding to the first side 12 of the final gas sorption rotor 10. The at least partly laser marked surface 32 comprises marks 34 for enabling identification of the respective rotor sections 30 formed from the rotor media block 100. The marks 34 covers different areas, each area shaped as a type of rotor section 30. This will facilitate the manufacturing process when machining the rotor sections 30 from the block 100. In this example, the mark 34 is different for different types of rotor sections 30. It is to be understood that even though it is not shown in the figure, the second side 114 of the block 100, opposite to the first side 112, may also comprise an at least partly laser marked surface 32.

FIG. 5 illustrates laser marking at least a part of a surface of rotor media 20. The rotor media 20 may be in the form of a block 100 or a rotor section 30. The laser marking is performed by slightly burning the top surface of the rotor media 20 with a thin and programmable laser beam. The laser marking will remove perceptible projections and smoothen the surface 32 of the rotor media 20. This is shown in the figure where the surface to the left is laser marked and the surface to the right is untreated.

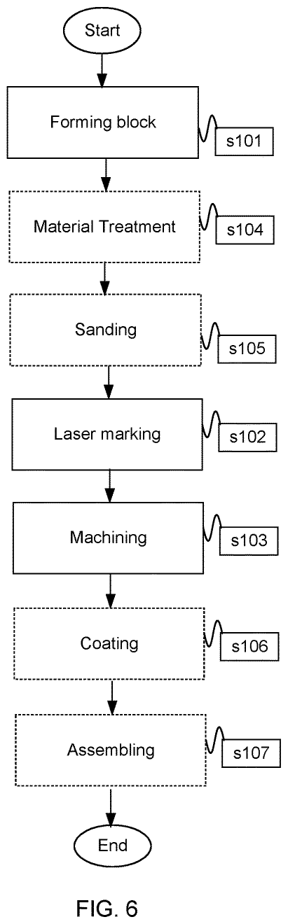

FIG. 6 schematically illustrates a method for manufacturing a gas sorption rotor 10 according to the present invention. The method is used to manufacture a gas sorption rotor 10 as disclosed in any of FIGS. 1-5.

The method comprises forming s101 a block 100 of rotor media 20, the rotor media 20 comprising corrugated panels 21 forming channels 22 extending through the block 100, from a first side 112 to a second opposite side 114 of the block 100, the first side 112 and the second side 114 of the block 100 corresponding to a first side 12 and second side 14 of the final gas sorption rotor 10. The step of forming s101 a block 100 of rotor media 20 may comprise performing a first material treatment of the raw material used for the gas sorption rotor 10. The first material treatment may involve chemical dipping of the raw material and the chemical treatment depends on the application for which the gas sorption rotor 10 will be used. After the first material treatment, the treated raw material may be heated to fix and dry the material. Subsequently, the material is corrugated and panels 21 including one corrugated sheet and one flat sheet of material are formed. The panels 21 are then stacked into a block 100 of rotor media 20.

The method further comprises machining s103 the block 100 into at least one rotor section 30 for a gas sorption rotor 10. This step suitably comprises CNC machining the block 100.

Furthermore, the method comprises the step of laser marking s102 at least a part of at least one surface 32 of the rotor media 20, such that the at least one rotor section 30 will have an at least partly laser marked surface 32 on a side corresponding to the first 12 and/or second side 14 of the gas sorption rotor 10. The step of laser marking s102 at least a part of at least one surface 32 of the rotor media 20 on a side corresponding to the first 12 and/or second 14 side of the gas sorption rotor 10 may comprise creating a mark 34 configured to enable identification of a rotor media configuration of said rotor section 30. The mark 34 may be configured to enable optical identification of the rotor media configuration of the rotor section 30. The step of laser marking s102 the at least one surface 32 may be an iterative process where the whole surface is first laser marked with a first relatively low intensity and/or power to make the surface smooth and subsequently a mark 34 is created by performing laser marking on parts of the surface with a second increased intensity and/or power. Alternatively, the laser marking s102 is performed in one step, alternating between different intensities.

The laser marking s102 may be performed on the block 100 of rotor media 20, prior to the machining s103 of the block 100 into at least one rotor section 30. Alternatively, the laser marking s102 is performed after the machining s103 of the block 100 into rotor sections 30 and is thus performed on the rotor section 30.

The step of laser marking s102 may further comprise laser marking at least a part of a surface on a side of the at least one rotor section 30 corresponding to the circumferential side 16 of the gas sorption rotor 10.

The method may further comprise a second material treatment s104 of the block 100 of rotor media 20. The second material treatment s104 may involve chemical dipping. After such material treatment, the block 100 is typically dried for hardening and this may also cause a change of colour of the rotor media 20.

The method may also comprise a step of sanding s105 the first 112 and second side 114 of the rotor media block 100, wherein the laser marking s102 is performed after the sanding s105.

The method may further comprise applying s106 a transparent coating 40 on the at least partly laser marked surface 32 on the first 12 and/or second side 14 of the gas sorption rotor 10. The coating 40 will harden the surface 32. The coating 40 may be applied s106 in conventional ways, for example by spraying the coating over the rotor media.

The method may also comprise the step of assembling s107 rotor sections 30 into a gas sorption rotor 10.

It should be noted that the examples shown in the drawings are for illustrating purposes only, and many other alternatives may be contemplated within the scope of the present invention.

1. A gas sorption rotor for air treatment, the gas sorption rotor comprising:
a first side;
a second side opposite to the first side;
a circumferential side;
a rotor media with corrugated panels forming channels extending in an axial direction through the gas sorption rotor in parallel with a rotational axis of the gas sorption rotor, wherein the channels extend from the first side to the second side; and
a rotor section of rotor media having an at least partly laser marked surface the at least partly laser marked surface being on at least one of said first and second side of the gas sorption rotor.

2. The gas sorption rotor according to claim 1, comprising a plurality of at least partly laser marked surfaces on the first side and/or second side of the gas sorption rotor.

3. The gas sorption rotor according to claim 1, wherein the circumferential side of the gas sorption rotor comprises an at least partly laser marked surface.

4. The gas sorption rotor according to claim 1, wherein the at least partly laser marked surface of the rotor section comprises a mark configured to enable identification of a rotor media configuration of said rotor section.

5. The gas sorption rotor according to claim 4, wherein the mark is configured to enable optical identification of the rotor media configuration of the rotor section.

6. The gas sorption rotor according to claim 1, further comprising a transparent coating applied on the at least partly laser marked surface of the gas sorption rotor

7. A method for manufacturing a gas sorption rotor for air treatment, the method comprising:
forming a block of rotor media the rotor media comprising corrugated panels forming channels extending through the block from a first side to a second opposite side of the block the first side and the second side of the block corresponding to a first side and second side of the final gas sorption rotor;
machining the block into at least one rotor section for a gas sorption rotor; and
laser marking at least a part of at least one surface of the rotor media such that the at least one rotor section will have an at least partly laser marked surface on a side corresponding to the first and/or second side of the gas sorption rotor.

8. The method according to claim 7, wherein the laser marking is performed on the block of rotor media, prior to the machining of the block into at least one rotor section.

9. The method according to claim 7, wherein the laser marking is performed on the rotor media after the machining of the block into at least one rotor section

10. The method according to claim 7, further comprising a step of sanding the first and second side of the rotor media block wherein the laser marking is performed after the sanding

11. The method according to claim 7, wherein the step of laser marking at least a part of at least one surface comprises creating a mark configured to enable identification of a rotor media configuration of the rotor section comprising said mark.

12. The method according to claim 7, further comprising:
applying a transparent coating on the at least partly laser marked surface of the rotor media.
